(19) United States
(12) Patent Application Publication
(10) Pub. No.: US 2010/0135381 A1
(43) Pub. Date: Jun. 3, 2010

(54) ENCODING/DECODING DEVICE AND VIDEO TRANSMISSION SYSTEM

(75) Inventors: Masaki HAMAMOTO, Kokubunji (JP); Masatoshi KONDO, Kodaira (JP); Masatoshi TAKADA, Kodaira (JP); Muneaki YAMAGUCHI, Inagi (JP); Takanobu TSUNODA, Kokubunji (JP); Takafumi YUASA, Musashino (JP)

Correspondence Address: MATTINGLY & MALUR, P.C., 1800 DIAGONAL ROAD, SUITE 370, ALEXANDRIA, VA, 22314, US

(73) Assignee: HITACHI KOKUSAI ELECTRIC INC., Tokyo (JP)

(21) Appl. No.: 12/621,592

(22) Filed: Nov. 19, 2009

(30) Foreign Application Priority Data
Nov. 28, 2008 (JP) 2008-303427

(51) Int. Cl. H04N 7/12; H04N 5/225

(52) U.S. Cl. 375/240.01; 348/207.11; 375/E07.076; 348/E05.042

(57) ABSTRACT

The present invention relates to a video transmission system that uses an encoding/decoding technique. An object of the present invention is to refrain from using a memory for storing decoded image data, avoid a decoder input buffer problem (buffer overflow or underflow) with ease, achieve cost reduction, and provide enhanced image quality. In the video transmission system with an encoding/decoding device, a reference signal for adjusting a synchronization schedule of the entire system is generated and supplied to various sections. In addition, a timing adjustment amount for adjusting the synchronization schedule for the reference signal is generated by a decoder and supplied to a camera.

### CLAIM OF PRIORITY

The present application claims priority from Japanese patent application JP2008-303427 filed on Nov. 28, 2008, the content of which is hereby incorporated by reference into this application.

### BACKGROUND OF THE INVENTION

(1) Field of the Invention

The present invention relates to a moving picture compression encoding system, a decoding system, a video encoding/decoding device, a video transmission system, and a video transmission method.

(2) Description of the Related Art

In a video transmission system used, for instance, at a broadcasting station, image data obtained by a camera is compression-encoded at a transmitting end (on an encoder side) and transmitted through a transmission path. The transmitted image data is then decoded at a receiving end, temporarily stored in a frame memory, and output in synchronism with a monitor's vertical synchronization signal. The obtained image data is then displayed as a moving picture. The video transmission system described above typically includes a camera capable of encoding picked-up image data and transmitting the encoded image data, and a camera control unit capable of decoding the encoded image data and outputting the decoded image data. An encoder is usually integrated into the camera, which has an image pick-up function. Further, a wired transmission path is used to connect the camera to the camera control unit. Although there are various image data compression encoding formats, MPEG-2 TS (MPEG-2 Transport Stream) is mainly used in the field of broadcasting and communication.

In the field of broadcasting and communication, data is incessantly transmitted from a transmitting ending. It is therefore necessary to synchronize the system clocks of an encoder side (transmitting end) and a decoder side (receiving end). Failure to synchronize the system clocks of the transmitting end and receiving end will result, for instance, in a video frame rate mismatch or a decoder side input buffer problem such as a buffer overflow or underflow.

Conventionally, MPEG-2 TS has been used in such a manner as to synchronize the system clocks of an encoder side and a decoder side by including time information, such as a PCR (Program Clock Reference), PTS (Presentation Time Stamp), and DTS (Decoding Time Stamp), in video data and audio data to be transmitted and transmitting a combination of such time information, video data, and audio data from the encoder side to the decoder side. The PCR, PTS, and DTS are pieces of time information indicating the date and time of each of various processes performed on the video data and audio data to be transmitted, stored in the header of a TS packet, and transmitted. The PCR is the information that serves as a system time reference value for the decoder side, and used to achieve time synchronization and clock synchronization with respect to STC (System Time Clock), which is the reference system time for the decoder side. The PTS is the time information indicating the time of display of a decoded image and attached to each picture. The DTS is timing information indicating the decoding time, and attached to a picture encoded by means of bilaterally predictive motion compensation or other picture whose display time differs from its decoding time.

A decoder can obtain the display time and decoding time of each picture by comparing the time indicated by the PTS or DTS against the time indicated by the STC. Further, the encoder side exercises VBV (Video Buffering Verifier) control to avoid a decoder side input buffer problem. VBV control is exercised to let the encoder side generate a decoder side input buffer virtually and allow an encoder to monitor the virtually generated input buffer (hereinafter referred to as the VBV buffer) for the purpose of estimating the amount of decoder side input buffer use (hereinafter referred to as the VBV buffer occupancy amount). To avoid a VBV buffer problem, the encoder controls the size of image information to be transmitted to the decoder side in accordance with the VBV buffer occupancy amount. The image information size can be controlled by controlling quantization parameters for encoding. A conventional generated code amount control method, which has been described above, entails the use of time information such as PCR, PTS, and DTS because it presumes that the VBV buffer is equal to the input buffer in buffer occupancy amount.

Further, when a conventional technology is used, decoded image information is temporarily stored in a frame memory positioned subsequent to the decoder and then output to an image display device. A technology disclosed, for instance, in Japanese Patent Application Laid-Open Publication No. 05-191801 stores decoded image information, frame by frame, in memory banks of a frame memory, and reads or writes frames independently on an individual memory bank basis to ensure that frames are smoothly read without jumpiness.

As described above, conventional technologies synchronize operations on the encoder side and decoder side by using time information such as the PCR and time stamps (PTS, DTS, etc.). Concurrently, the conventional technologies temporarily store a decoded image in the frame memory and then display the decoded image on a monitor in accordance with a vertical synchronization signal, thereby making it possible to display the decoded image information as a moving picture.

### BRIEF SUMMARY OF THE INVENTION

A conventional video transmission system reads a decoded image stored in the frame memory at a predetermined frame rate (typically in a cycle synchronized with a moving picture's vertical synchronization signal) and then displays a moving picture. Before displaying image data, the conventional video transmission system performs two processes: a process for storing decoded data in the frame memory and a process for reading the data from the frame memory. Therefore, there is a delay between image pick-up and image display. The delay is equivalent to the time required for a storage process and a read process. It is demanded that the video transmission system minimize the delay between image pick-up and display. From the viewpoint of low delay, therefore, the use of the frame memory is not preferred.

Further, when the video transmission system is to be used, it is frequently carried to a place where a subject exists. It is therefore desired that the video transmission system be small in size. However, the frame memory for storing decoded image data needs to have a significantly larger capacity than the decoder side input buffer. Consequently, it is difficult to integrate the decoder and frame memory into a single chip. This would be an obstacle to system size reduction and cost reduction.

Moreover, the conventional video transmission system uses time information, such as the PCR, PTS, and DTS, to provide synchronization control over the encoder and decoder. Therefore, for example, parts and circuits for processing such time information are necessary for both the transmitting end and receiving end. It means that exercising control on the basis of time information makes encoder and decoder circuit configurations complex. This would be an obstacle to cost reduction.

The present invention has been made in view of the above circumstances. An object of the present invention is to provide an encoding/decoding device that is capable of achieving synchronization between an encoder and a decoder and between a decoder output signal and a frame rate without using time information or a frame memory. Another object is to provide a video transmission system in which the above encoding/decoding device is incorporated.

The present invention provides a video transmission system that includes an encoding/decoding device. The encoding/decoding device includes a camera, which encodes picked-up image data and outputs the encoded image data, and a camera control unit, which decodes the encoded image data and outputs the decoded image data. This video transmission system addresses the aforementioned problems by providing the camera control unit with a reference signal for adjusting an overall system operation schedule with reference to a frame display cycle and allowing the camera control unit to instruct the camera to operate according to a predetermined schedule based on the frame display cycle. The operations of the camera and camera control unit are then adjusted in accordance with the reference signal. This makes it possible to output the decoded image data in synchronism with the frame display cycle.

Therefore, the camera control unit starts decoding the encoded image data at a time earlier than indicated by the above reference signal by the amount of time required for decoding, whereas the camera starts acquiring the subject's image data (that is, starts supplying the image data to an encoding device) at a time earlier than indicated by the above reference signal by a predetermined amount of time. A series of the operations described above is controlled so that they occur within an assert cycle of the above reference signal.

Further, the camera control unit generates, in accordance with the above reference signal, a timing adjustment amount for synchronizing the overall system operation schedule with the cycle of the above reference signal, and transmits the generated timing adjustment amount to the camera.

The present invention makes it possible to implement an encoding/decoding device and a video transmission system that significantly reduce the delay between the start of image pick-up and the display of a moving picture. The present invention also makes it possible to implement a video encoding/decoding device and a video transmission system that are suitable for downsizing and cost reduction due to their simple circuit configurations.

### BRIEF DESCRIPTION OF THE DRAWINGS

FIG. 1 is an overall view of a video transmission system according to a first embodiment of the present invention;

FIG. 2 is a diagram illustrating the internal configuration of an encoding/decoding device shown in FIG. 1;

FIG. 3 is a conceptual diagram illustrating buffer occupancy amount changes based on VBV buffer control according to the first embodiment;

FIG. 4 is a timing diagram illustrating the schedule synchronization of the encoding/decoding device according to the first embodiment;

FIG. 5A is a functional block diagram illustrating the internal configuration of an encoder device;

FIG. 5B is a functional block diagram illustrating the internal configuration of a decoder device;

FIG. 6 is a detailed functional block diagram illustrating the internal configuration of an encoder device;

FIG. 7 is a timing diagram illustrating the schedule synchronization of an encoding/decoding device according to a second embodiment of the present invention;

FIG. 8A is a conceptual diagram illustrating VBV buffer occupancy amount changes for the purpose of describing a problem to be addressed by the second embodiment;

FIG. 8B is a conceptual diagram illustrating decoder side input buffer occupancy amount changes for the purpose of describing a problem to be addressed by the second embodiment;

FIG. 9 is a functional block diagram illustrating a code amount control section according to the second embodiment;

FIG. 10 is a conceptual diagram illustrating VBV buffer occupancy amount changes encountered when the configuration of the second embodiment is employed;

FIG. 11 is a timing diagram illustrating the schedule synchronization of an encoding/decoding device for the purpose of describing a problem to be addressed by a third embodiment of the present invention;

FIG. 12 is a timing diagram illustrating the schedule synchronization of the encoding/decoding device in a situation where the configuration of the third embodiment is employed; and

FIG. 13 is an overall view of a video transmission system according to a fourth embodiment of the present invention.

### DETAILED DESCRIPTION OF THE INVENTION

Various embodiments of the present invention will now be described with reference to the accompanying drawings.

### First Embodiment

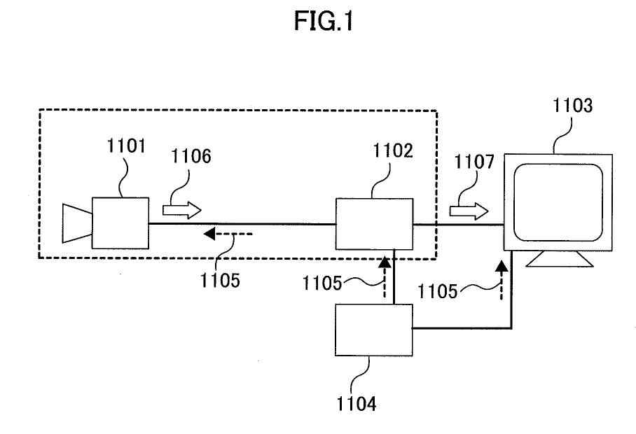

FIG. 1 is a schematic diagram illustrating the basic configuration of a video transmission system according to a first embodiment of the present invention. The video transmission system shown in FIG. 1 includes a camera 1101, a camera control unit 1102, a monitor or other image output device 1103, and a host system control device 1104, which are interconnected with transmission cables. However, the host system control device 1104 is wired only to the camera control unit 1102 and image output device 1103. The reason that if the host system control device is wired to the camera, two cables connect to the camera, thereby significantly reducing the portability of the camera. The transmission cables may vary in length. However, the transmission cable length generally ranges from several hundred meters to several kilometers. Certain cable lengths are predefined by a standard. The camera control unit 1102 is positioned closer to the host system control device 1104 and image output device 1103 than is the camera 1101. A switcher and other device elements may be positioned between the camera control unit 1102 and image output device 1103.

A broken line in the figure indicates that the camera 1101 and camera control unit 1102 constitute an encoding/decoding device. The subsequent description assumes that the term “encoding/decoding device” refers to a hardware configuration that is composed of a combination of the camera and camera control unit. It is also assumed that the term “video transmission system” refers to a system including the camera, camera control unit, host system control device, and output device. The term “output device” does not always denote an image output device. The reason is that a switcher or an element other than the image output device may be included as an output device.

The host system control device 1104 generates a signal that is synchronized with the frame display cycle of the image output device 1103, and transmits the generated signal to various sections of the system. A broken-line arrow 1105 indicates the direction of transmission of a reference signal. Arrows 1106 and 1107 indicate the direction of encoded data transmission or decoded data transmission. The camera 1101 transmits encoded picked-up image data to the camera control unit 1102 at predefined timing calculated from the reference signal. Similarly, the camera control unit 1102 decodes the received encoded data by performing arithmetic processing at a predefined timing calculated from the reference signal, and transmits the decoded data to the image output device 1103.

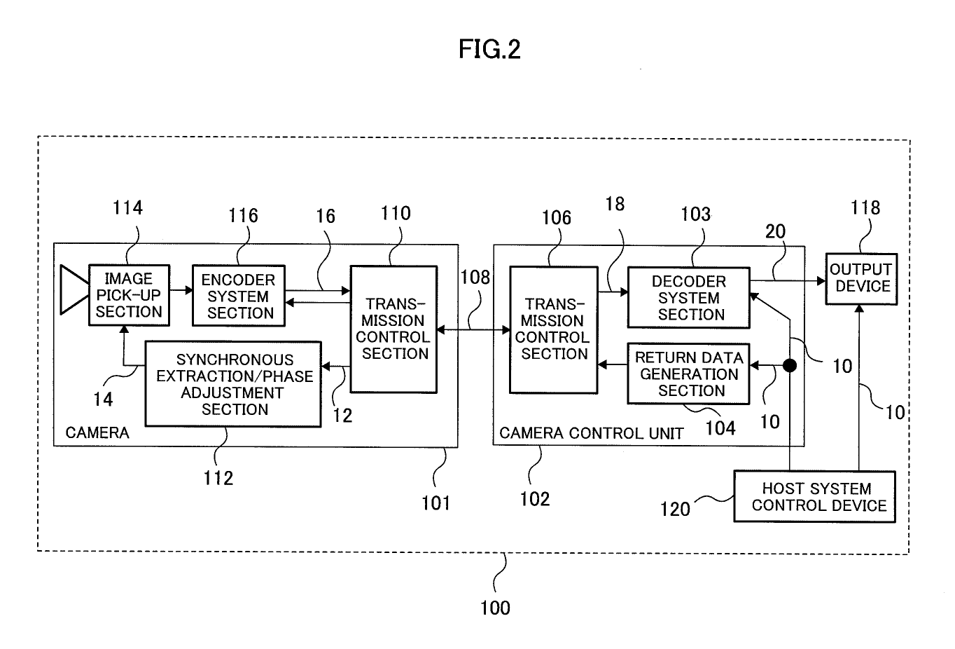

FIG. 2 is a functional block diagram illustrating the internal configuration of the camera 1101 and camera control unit 1102 shown in FIG. 1. To depict signal transmissions, FIG. 2 additionally illustrates the output device 118 and host system control device.

The video transmission system 100 shown in FIG. 2 can be roughly divided into four device elements: a camera 101, a camera control unit 102, an image output device 118, and a host system control device 120. The camera 101 is capable of encoding picked-up image data and transmitting the encoded image data. The camera control unit 102 is capable of performing a decoding process and various other arithmetic processes on received encoded image data. The image output device 118 displays arithmetically-processed image data as a moving picture. The host system control device 120 provides overall system control. A transmission cable 108 capable of providing bidirectional communication is connected between the camera 101 and camera control unit 102, between the host system control device 120 and camera control unit 102, and between the host system control device 120 and image output device 118.

The host system control device 120 generates a system synchronization signal 10 for synchronizing the entire system with the frame display cycle of the image output device 118, that is, the vertical synchronization signal of a monitor, and then outputs the generated signal to various sections of the system. As shown in FIG. 2, the system synchronization signal 10 is transmitted to the camera control unit 102 and output device 118 directly from the host system control device 120, and transmitted to the camera 101 through the camera control unit 102.

Transmitting the system synchronization signal 10 to the camera control unit 102 and then to the camera 101 increases the system's tolerance to a communication trouble between the camera 101 and camera control unit 102. In general, the communication trouble between the device elements of the video transmission system 100 is most likely to occur between the camera 101 and camera control unit 102 because of a long wiring distance. If a communication trouble occurs between the camera 101 and camera control unit 102 (if, for instance, a cable breaks or a transmission control section 110, 106 malfunctions) in a situation where the system synchronization signal 10 is forwarded from the camera 101 to the camera control unit 102, the system synchronization signal 10 is not supplied to the camera control unit 102 and output device 118. Consequently, the reference signal is lost so that a displayed image becomes disordered.

On the other hand, when the system synchronization signal 10 is supplied from the camera control unit 102 to the camera 101 in accordance with the present embodiment, the influence of a communication trouble is confined to the camera 101, which is a device element positioned at the most downstream end as viewed from the host system control device 120. Therefore, the camera control unit 102 and output device 118 remains controllable. In other words, even if a communication trouble occurs, it merely affects the display of image data that is left untransmitted during a period during which the communication trouble exists. Further, the influence of the communication trouble can be rendered relatively small because various error concealment technologies can be applied. It is obvious that the transmission sequence of the system synchronization signal 10 should be changed if a communication trouble is likely to occur at a location other than the path between the camera 101 and camera control unit 102.

The host system control device 120 not only exercises overall synchronization control over the video transmission system 100, but also outputs to each device element various control parameters necessary for the camera, camera control unit, and image output device. Therefore, the host system control device 120 includes a user interface for the input of the various control parameters.

The camera 101 includes a transmission control section 110, a synchronous extraction/phase adjustment section 112, an image pick-up section 114, an encoder system section 116, and a terminal for cable connection. The camera 101 is a device capable of picking up an image, encoding image data derived from image pick-up, and outputting the encoded image data to the camera control unit. The operation of each section is controlled with reference to the system synchronization signal 10. Various signals are physically input or output through the aforementioned terminal.

The image pick-up section 114 is a device that acquires the image of a subject, converts the acquired image to a digital signal, and outputs the digital signal. It includes an optical element, such as a CCD or CMOS sensor, and an analog-to-digital converter. Obtained image data is periodically output to the encoder system section 116 at a timing synchronized with a camera output reference signal, which is calculated from the system synchronization signal 10. The camera output reference signal is used for timing adjustment of a video output from the image pick-up section 114. It is generated by the synchronous extraction/phase adjustment section 112 and supplied to the image pick-up section 114. The image pick-up section 114 outputs image data to the encoder system section 116 in accordance with the camera output reference signal.

The synchronous extraction/phase adjustment section 112 generates the camera output reference signal from an entered system synchronization signal. For the generation of the camera output reference signal, for example, a phase adjustment amount transmitted from the camera control unit 102 is used in addition to the system synchronization signal. The generated camera output reference signal is periodically output to the image pick-up section 114.

The encoder system section 116 compression-encodes video and audio data entered from the image pick-up section 114, converts the encoded data to stream data, and outputs the stream data to the transmission control section 110. For compression-encoding purposes, for example, control parameters transmitted from the host system control device 120 and camera control unit 102 may be used in addition to the image data entered from the image pick-up section 114.

The transmission control section 110 is an encoder side transmission control device, which controls transmissions and receptions in a bidirectional transmission path 108. Transmission control is exercised so that the transmission control section 100 generates a TS packet by multiplexing stream data, clock information, and the like, and outputs the generated TS packet to the bidirectional transmission path 108. Reception control is exercised so that the transmission control section 110 separates a received packet into a header and a body, and extracts return data, such as the system synchronization signal, from the body. The return data is a set of various control parameters such as the phase adjustment amount and the parameter information to be input into the encoder system section 116. The system synchronization data 10 is also included in the return data. The extracted various information is output to various sections of the camera 101.

The camera control unit 102 includes a decoder system section 103, a return data generation section 104, and a decoder side transmission control section 106. The camera control unit 102 is capable of receiving a TS packet transmitted from the camera 101, exercising decoding control in accordance with the system synchronization signal 10 and various control parameters, and outputting decoded image data to the output device 118. Further, the camera control unit 102 outputs to the camera 101 the system synchronization signal 10, various control parameters, and various parameters and other information generated by the camera control unit 102.

As is the case with the camera 101, the camera control unit 102 also includes a terminal. More precisely, however, the camera control unit 102 includes three terminals: a first terminal for connecting to the camera 101, a second terminal for connecting to the output device 118, and a third terminal for connecting to the host system control device 120.

The operation and function of the transmission control section 106 will not be described here because they are substantially the same as those of the camera side transmission control section 110.

The decoder system section 103 is a device element that receives stream data from the transmission control section 106, decodes the received stream data at a timing determined from the system synchronization signal 10, and outputs the decoded data to a subsequent device. The return data generation section 104 generates various return data.

The output device 118 displays image data that is output from the camera control unit 102. As the host system control device 120 generates the system synchronization signal in accordance with the vertical synchronization signal of a monitor, the frame display cycle of the output device 118 synchronizes with the system synchronization signal 10. Although the output device 118 may be, for example, a monitor, a switcher, or a different encoding device (transcoder), it operates in synchronism with the system synchronization signal 10 irrespective of its type.

In the present embodiment, the camera control unit 102 is connected to the camera 101 through the bidirectional transmission path 108. The bidirectional transmission path is a transmission path that complies with a data transfer standard for bidirectional transmission. Data transmissions between upstream and downstream ends are performed distributively by a time-division method. When stream data is transmitted from the camera 101 to the camera control unit 102, transmission control is exercised by the transmission control section 106 and transmission control section 110 to omit the transmission of a marginal portion, which has no image information, of encoded image data. Extra time afforded by such omission is then used by the camera control unit 102 to transmit the system synchronization signal and other return data to the camera 101. For bidirectional transmission purposes, a frequency-division method may be used instead of the time-division method. However, bidirectional communication based on the time-division method is more suitable for long-distance transmission than bidirectional communication based on the frequency-division method.

The use of the above-described bidirectional transmission method makes it possible to transmit encoded image data and return data, such as the system synchronization signal, with one transmission cable, thereby simplifying the system configuration and facilitating the movement of the camera 101. An electrical cable or optical fiber cable can be used as a transmission cable for the bidirectional transmission path 108.

The foregoing description assumes that the output device 118 and host system control device 120 are separate devices. However, these devices may alternatively be placed in the same housing as for the camera control unit 102. Further, the constituent elements of the camera control unit 102, the encoder system section 116, the synchronous extraction/phase adjustment section 112, and the transmission control section 110 are often implemented by hardware because it is necessary to process a large amount of image data at a high speed. Alternatively, however, a high-speed processor may be incorporated to implement all such elements by software.

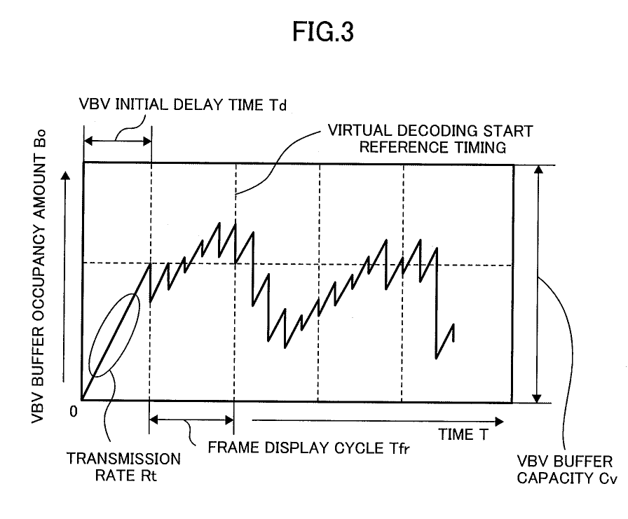

The operation of a VBV buffer will now be described with reference to FIG. 3. As described earlier, the encoder system section 116 generates the VBV buffer virtually and monitors the amount of VBV buffer use to estimate the amount of decoder side input buffer use. The vertical axis of FIG. 3 represents a VBV buffer occupancy amount Bo. Its maximum value denotes a VBV buffer capacity Cv. The VBV buffer capacity Cv is equal to the capacity of an input buffer 210. The horizontal axis of FIG. 3 indicates the elapsed time T from reference time 0, which is the instant at which stream reception starts. Virtual decoding start timing, which is indicated by vertical broken lines, represents a virtual time at which a decoder starts a decoding process by extracting stream data at the beginning of a frame from the input buffer. The cycle of such virtual decoding is the frame display cycle Tfr. Here, it is assumed that the decoder extracts data from the VBV buffer on each cycle of decoding time (Tfr/N) for a predetermined image size Sn, which is obtained by dividing a frame by N. N is an arbitrary natural number. FIG. 3 assumes that N=5. The gradient of a graph shown in FIG. 3 is a transmission rate Rt, which is constant because it is not dependent on the time T.

Changes in the amount of data in the VBV buffer, which are indicated by the solid line in FIG. 3, will now be described. It is initially assumed that stream data is continuously stored for a predetermined period of time after the start of stream data reception by the VBV buffer. The predetermined period of time is referred to as the VBV initial delay time Td because it denotes initial storage time. Between time 0 and time Td, the solid line linearly increases at a constant gradient. Stream data reception start time (time 0 in FIG. 3) can be obtained, for instance, by detecting an AU delimiter attached to the beginning of each frame data in a stream.

Decoding starts when the VBV initial delay time Td elapses. For each decoding process, stream data for the image size Sn is extracted from the input buffer 210 in a cycle of Tfr/N. Therefore, the VBV buffer periodically outputs the first data of each frame in a cycle of Tfr after the elapse of the VBV initial delay time Td. In the example shown in FIG. 3, N=5. After the elapse of Td from time 0, the solid line zigzags, that is, increases at a constant gradient between Td and Td+n×Tfr/N (n is an integer between 1 and 5) and decreases by Sn at time Td+n×Tfr/N. The time at which the first data of a frame is output is referred to as the virtual decoding start reference timing. A pulse signal synchronized with this time (a decoding start reference signal, which will be described later) is generated in an encoder device 200 and in a decoder device 212. The decoding start reference signal is used for internal control of the decoder system section 103.

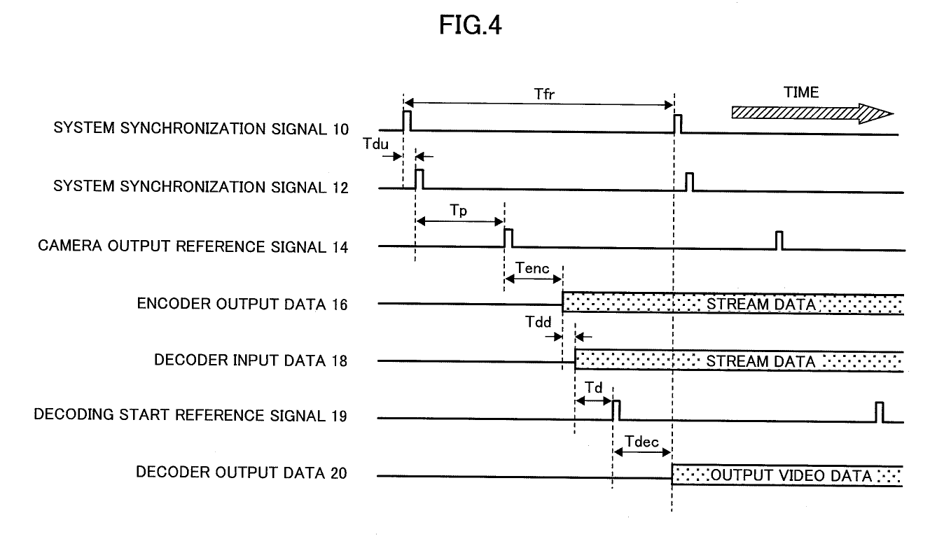

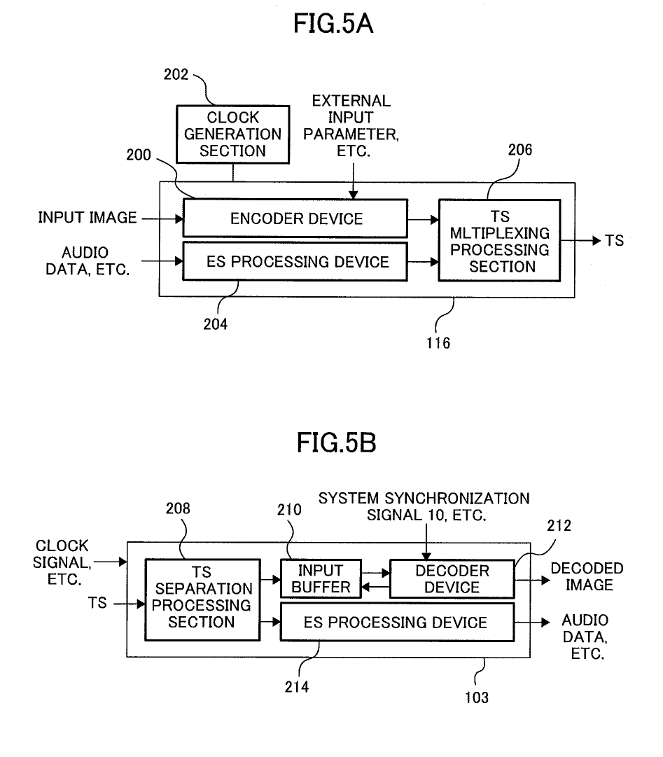

In a conventional encoding/decoding device that uses the PCR, PTS, and DTS, the encoder side transmits a time stamp, such as the PTS or DTS, to the decoder side to specify the time at which the decoder side starts an actual decoding process. On the other hand, in the encoding/decoding device according to the present embodiment, which does not use a time stamp or other time information, a certain method must be used to ensure that the virtual decoding start reference timing predicted by the encoder side coincides with the decoding start time for the first frame on the decoder side. If such coincidence is not achieved, the VBV buffer occupancy amount at certain time T does not agree with a decoder side input buffer occupancy amount. It means that a buffer overflow or underflow occurs sooner or later even when encoding is performed while monitoring the VBV buffer. A control method for avoiding an input buffer problem (buffer overflow or underflow) without using a time stamp or other time information will be described below with reference to FIGS. 4, 5A, 5B.

First of all, the operation of the encoder side will be described. FIG. 4 is a timing diagram illustrating the operation of each device element of the video transmission system shown in FIG. 2. Numbers assigned to signals shown in FIG. 4 correlate to the numbers assigned to the signals shown in FIG. 2. FIGS. 5A and 5B are diagrams illustrating in detail the internal configuration of the encoder system section 116 or decoder system section 103 shown in FIG. 2.

When an image is to be picked up with the video transmission system, the host system control device 120 generates the system synchronization signal 10 and transmits it to the camera control unit 102 and output device 118. Further, the system synchronization signal 10 is transferred from the camera control unit 102 to the camera 101 through the bidirectional transmission path 108. The system synchronization signal 10 is a pulse signal whose cycle is equal to the frame display cycle Tfr of an image. The host system control device 120 generates the system synchronization signal 10 in accordance with information (cycle, frequency, etc.) about the characteristics of a moving picture to be displayed eventually so that the cycle of the system synchronization signal 10 agrees with the frame display cycle Tfr.

A system synchronization signal 12 shown in FIG. 4 represents a system synchronization signal that has been transmitted from the camera control unit 102 to the camera 101, and is extracted by the synchronous extraction/phase adjustment section 112 of the camera 101. Because of the length of the bidirectional transmission path 108, the system synchronization signal 12 is a signal that is delayed from the system synchronization signal 10 by the amount of transmission delay time Tdu. In reality, the transmission delay time Tdu includes the time required for packet processing in the transmission control section and the time required for signal processing in the synchronous extraction/phase adjustment section 112. However, the amount of time required for such processing operations is insignificant and negligible.

Upon receipt of the system synchronization signal 12, the transmission control section 110 of the camera 101 separates the body from the header and transfers the body to the synchronous extraction/phase adjustment section 112.

The synchronous extraction/phase adjustment section 112 generates the camera output reference signal 14 by delaying the transferred system synchronization signal 12 by the phase adjustment amount Tp. The camera output reference signal 14 is a synchronization reference signal that is generated by the synchronous extraction/phase adjustment section 112 after phase adjustment. This signal provides the image pick-up section 114 with a timing for video output to the encoder system section 116. The phase adjustment amount Tp is the amount of adjustment to be made by the encoder side to fine-tune the time of image output from the image pick-up section so that the output start time for decoded data from the decoder synchronizes with a frame synchronization signal. The phase adjustment amount Tp is generated by the return data generation section 104 of the camera control unit 102 and entered into the synchronous extraction/phase adjustment section 112 of the camera 101 as return data. The generated camera output reference signal 14 is supplied to the image pick-up section 114.

Upon receipt of the camera output reference signal 14, the image pick-up section 114 starts transmitting picked-up image data to the encoder system section 116. In other words, the video output start timing of the image pick-up section 114 is controlled in accordance with the camera output reference signal 14, which is calculated from the system synchronization signal 10 and return data. The encoder system section 116 sequentially encodes the image data transmitted from the image pick-up section 114 and outputs the encoded image data to the transmission control section 110.

The encoder device 200 in the encoder system section 116 performs an actual encoding process in accordance with a predefined clock supplied from a clock generation section 202. As shown in FIG. 5A, the encoder system section 116 includes, for instance, the encoder device 200, the clock generation section 202, an ES processing device 204 for processing audio and other data, and a TS multiplexing processing section 206.

The ES processing device 204 generates and outputs an audio ES (Elementary Stream) and auxiliary information for system control. The TS multiplexing processing section 206 generates stream data by multiplexing a stream (video ES) output from the encoder device 200 and an output of the ES processing device 204, such as the audio ES and the auxiliary information for system control.

The clock supplied from the clock generation section 202 is used not only for the encoder device 200 but also for the other constituent elements within the encoder system section 116. This clock generation process may be performed in the encoder system section 116. However, when, for instance, an input image is to be entered in compliance with an HD-SDI (High Definition Serial Digital Interface) or other similar signal standard, clock generation may alternatively be achieved by extracting a clock from such an input image.

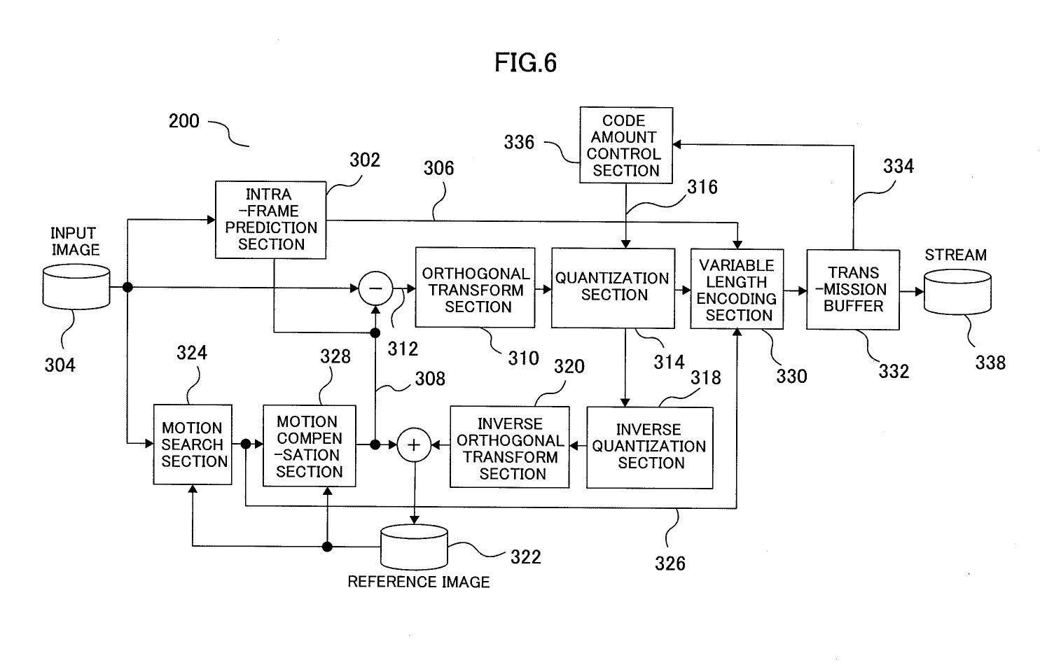

Stream data output from the encoder system section 116 is indicated as encoder output data 16 in FIG. 6. Basically, after the start of output, the stream data is continuously output until the image pick-up section 114 stops its image pick-up operation. The time at which the encoder system section 116 starts outputting the stream data is delayed from the camera output reference signal 14 by the encoding process time Tenc of the encoder system section 116. Tenc is a fixed length of time that is determined in accordance with the performance of the encoder system section 116. It is stored, for instance, in registers within the synchronous extraction/phase adjustment section 112 and return data generation section 104 and referenced for various control purposes.

The stream data transmitted to the transmission control section 110 is subjected to header processing and then transmitted through the transmission path 108 as a TS packet.

The operation of the camera control unit 102 will now be described. When a TS packet reaches the camera control unit 102, the decoder side transmission control section 106 subjects the TS packet to header processing and then transfers the processed TS packet to the decoder system section 103.

The input status of stream data entered into the decoder system section 103 is indicated in FIG. 4 as decoder input data 18. Stream data input start time is delayed from stream data output start time of encoder output data 16 by the sum of packetization time spent in the transmission control section 110, transmission delay time Tdd involved in the bidirectional transmission path 108, and header processing time spent in the transmission control section 110. However, the transmission delay time Tdd is dominant over the others. The magnitude of Tdd depends on the length of a cable used for the bidirectional transmission path 108.

Upon receipt of the system synchronization signal 10 at the beginning of image pick-up, the decoder system section 103 internally generates a decoding start reference signal 19. The decoding start reference signal 19 is a pulse signal indicating the time at which the decoder system section 103 actually starts decoding data stored in the input buffer 210.

As shown in FIG. 5B, the decoder system section 103 includes, for instance, a TS separation processing section 208, the input buffer 210, the decoder device 212, and an ES processing device 214 for processing audio and other data.

The decoder device 212 decodes, that is, decompression-decodes video stream data, and outputs the resulting decoded image, that is, the decompression-decoded image data, to the subsequent output device 118. The input buffer 210 stores a video ES, that is, video stream data, and outputs the stored stream data in response to a request signal from the decoder device 212.

The decoding start reference signal 19 is actually generated in the decoder device 212. As the system synchronization signal 10 is supplied to the decoder device 212, the cycle of the system synchronization signal 10 enables the decoder device 212 to predict the time at which the next signal rise occurs. Therefore, the decoder device 212 generates a pulse signal rising at a time that is earlier than the rise time of the system synchronization signal 10 by a predetermined amount of time Tdec required for decoding imaged data extracted from the input buffer. The decoder device 212 generates such a pulse signal as the decoding start reference signal 19 and makes a count internally. The decoding start reference signal 19 rises at a time that is delayed from the stream data input start time of the decoder input data 18 by time Td. Tdec is an inherent value that varies with the performance of the decoder system section 103. Td is initial time for storing stream data in the input buffer and in agreement with the initial delay time Td of the VBV buffer.

Upon detection of a rise of the decoding start reference signal 19, the decoder device 212 transmits a request signal to the input buffer 210. In accordance with the request signal, the input buffer 210 transmits a predefined amount (e.g., Sn) of image data to the decoder device 212. The decoder device 212 decodes the stream data transmitted from the input buffer 210 and forwards the decoded data to the subsequent output device 118.

The TS separation processing section 208 receives the TS transmitted from the camera 101, and separate it into a video ES, an audio ES, and auxiliary information for system control. The ES processing device 214, for example, processes the auxiliary information for system control, decodes the audio ES, and outputs voice data. Here, the cycle of decoded video output timing and the assert cycle of the system synchronization signal 10 are equal to the frame display cycle.

In FIG. 4, decoder output data 20 indicates the status of decoded data output from the decoder system section 103 to the subsequent output device 118. The output of the decoded data starts when the decoding process time Tdec elapses after the pulse rise time of the decoding start reference signal 19, and coincides with the pulse rise time of the system synchronization signal. The reason is that the decoding start reference signal 19 is preset to rise at a time that is earlier by Tdec than the pulse rise time of the system synchronization signal.

As described above, the encoding/decoding device according to the present embodiment is configured so that the camera control unit 102, which is on the decoder side, controls the camera 101, which is on the encoder side. Tfr, Tdu, Tenc, Tdd, and Tdec, which are control parameters necessary for operating schedule synchronization control of the system, are fixed values determined by the hardware performance of the video transmission system and are not variable adjustment amounts. Although Td is a variable adjustment amount, its upper limit is defined in accordance with the capacity of the input buffer. Therefore, as far as the system synchronization signal 10 is supplied, the camera control unit 102 can predict and preset the start time of stream data input into the decoder system section 103 and the rise time of the decoding start reference signal 19. In addition, the camera 101 can predict and preset the rise time of the camera output reference signal 14 and the start time of stream data output from the encoder system section 116 as far as the system synchronization signal 10 and phase adjustment amount Tp are supplied.

The phase adjustment amount Tp for providing the timing shown in FIG. 4 can be calculated from Equation (1) below:

Tp=Tfr−Tdu−Tenc−Tdd−Td−Tdec (1)

As described with reference to FIGS. 4, 5A, and 5B, the encoding/decoding device according to the present embodiment avoids a buffer problem and displays a vertically synchronized moving picture by setting the decoding start time of the decoder in synchronism with the frame display cycle and adjusting the image data output start time of the image pick-up section 114 in accordance with the decoding start time.

The foregoing description assumes that the decoding start reference signal 19 is internally generated in the decoder device 212. Alternatively, however, the decoding start reference signal 19 may be generated in the host system control device 120 and transmitted to the camera control unit 102. For ease of explanation, the foregoing description also assumes that the image data output start time of the image pick-up section 114 is adjusted in accordance with the decoding start time (or the system synchronization signal 10). However, if the video output timing is practically controllable, the item to be adjusted is not limited to the video output timing of the image pick-up section.

FIG. 6 is a functional block diagram illustrating in detail the internal configuration of the encoder device 200 shown in FIG. 5A. When an MPEG encoding method is used, encoding is performed in two different prediction modes: intra-frame prediction and inter-frame prediction modes.

In intra-frame prediction mode encoding, stream generation is accomplished by performing an intra-frame prediction process, an orthogonal transform process, a quantization process, an inverse quantization process, an inverse orthogonal transform process, and a variable length encoding process. In inter-frame prediction mode encoding, on the other hand, stream generation is accomplished by performing a motion search process, a motion compensation process, an orthogonal transform process, a quantization process, an inverse quantization process, an inverse orthogonal transform process, and a variable length encoding process.

Each processing section shown in FIG. 6 will now be described. An intra-frame prediction section 302 generates intra-frame prediction information 306 and a prediction image 308 for input image prediction from an input image 304, which is input. An orthogonal transform section 310 performs an orthogonal transform to generate frequency components from a prediction residual 312, which is the difference between the prediction image 308 and input image 304. A quantization section 314 reduces the amount of information by quantizing the frequency components in accordance with a quantization parameter 316. An inverse quantization section 318 recovers the frequency components by subjecting the quantized frequency components to inverse quantization. An inverse orthogonal transform section 320 recovers the prediction residual by performing an inverse orthogonal transform on the recovered frequency components. The sum of the recovered prediction residual and prediction image 308 is stored as a reference image 322. Meanwhile, a motion search section 324 searches the reference image 322, which is generated from a past image or future image, for areas similar to those within the input image 304, and generates a motion vector 326 indicating the locations of the similar areas. In accordance with the locations indicated by the motion vector 326, a motion compensation section 328 references the reference image 322 and generates the prediction image 308 by performing a filtering process. A variable length encoding section 330 encodes the quantized frequency components, intra-frame prediction information 306, and motion vector 326 into a data string having a reduced amount of data, and stores the resulting data string in a transmission buffer 332. The transmission buffer 332 outputs a code data amount (hereinafter referred to as the actually generated code amount 334), which is acquired from the variable length encoding section 330, to a code amount control section 336. Further, the transmission buffer 332 stores code data for a predetermined period of time and then outputs the stored code data to the outside as a stream 338. The code amount control section 336 updates the status of the VBV buffer in accordance with the actually generated code amount 334, and determines the quantization parameter 316 while monitoring the VBV buffer.

As described above, the video transmission system or encoding/decoding device according to the present embodiment implements a low-delay device that does not require the use of a frame memory. Further, as the timing of decoded data output from the camera control unit synchronizes with the frame rate, a moving picture output from the decoder system section 103 can be displayed as-is by the output device 118. This obviates the necessity of using, for instance, a special control circuit for reading an image from a frame memory.

Further, the present embodiment makes it possible to implement an encoding/decoding device that has a simple circuit configuration, does without circuit elements for processing the PCR, PTS, and DTS, and provides the same functions as when the PCR, PTS, and DTS are used. For example, the video transmission system 100 according to the present embodiment can achieve flexible encoding while allowing the buffer occupancy amount to increase to the maximum capacity of the VBV buffer.

### Second Embodiment

A second embodiment of the present invention will now be described with reference to an exemplary configuration of a video transmission system or encoding/decoding device that is adaptable to different transmission cable lengths.

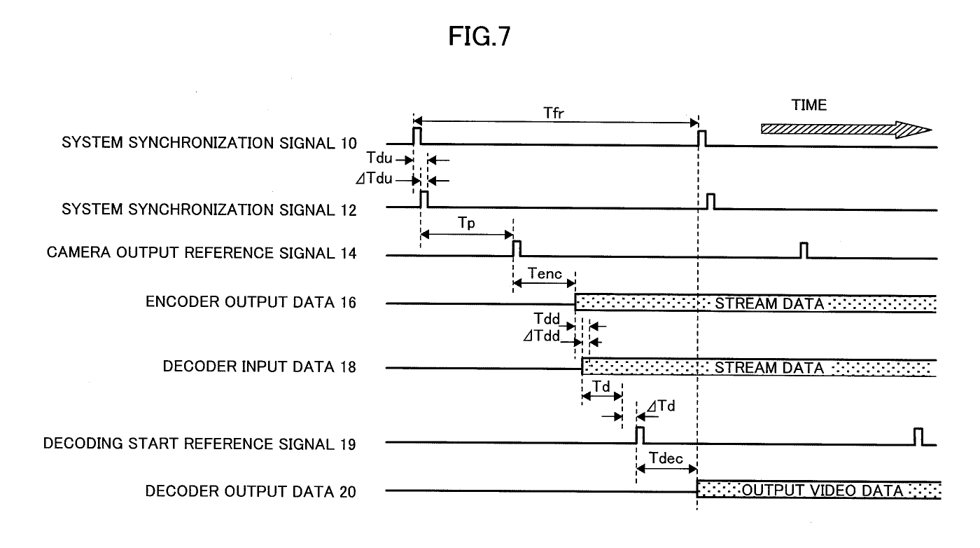

The rate of electrical signal transmission is limited. Therefore, a change in the transmission cable length will change the transmission delay time between the camera control unit 102 and camera 101. FIG. 7 is a timing diagram illustrating how the device elements in the video transmission system operate in a situation where the transmission cable length is shorter than in the first embodiment. Reference numerals in FIG. 7 correlate to the numbers shown in FIG. 2, as is the case with the reference numerals in FIG. 4.

As the transmission cable length is decreased, the transmission delay time is decreased. Therefore, a time lag of Td+ΔTd arises between the data input timing of the decoder input data 18 and the decoding start reference signal. If, for the sake of convenience, the signal transmission from the camera control unit to the camera is referred to as an up transmission, whereas the signal transmission in the opposite direction is referred to as a down transmission, a change ΔTd in the VBV initial delay time Td is expressed by Equation (2) below through the use of a change ΔTdu in up transmission delay time and a change ΔTdd in down transmission delay time:

ΔTd=ΔTdu+ΔTdd (2)

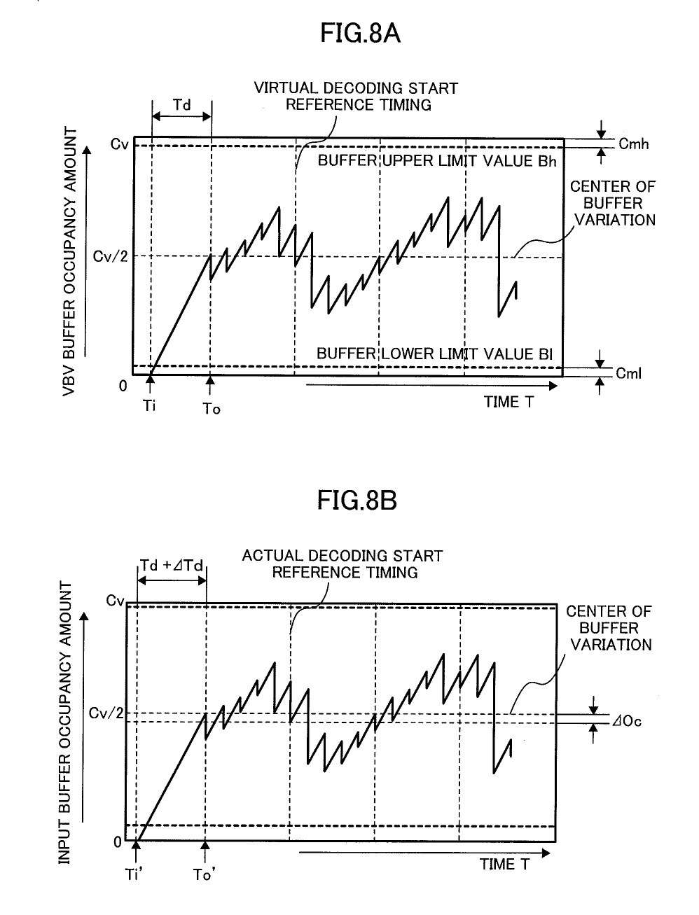

FIGS. 8A and 8B illustrate how changes in the transmission delay time affect the input buffer or VBV buffer occupancy amount. FIG. 8A shows changes in the VBV buffer occupancy amount. FIG. 8B shows changes in the decoder side input buffer occupancy amount. For ease of explanation, FIGS. 8A and 8B assume that the data transmission start time of the transmission buffer 332, that is, the data output start timing of the encoder output data 16, is reference time 0.

If the time at which the VBV buffer begins to receive the first data of a frame is expressed as Ti, time To, which represents virtual decoding timing, is expressed as the time that arrives when the VBV initial delay time Td elapses from the time Ti. The present embodiment assumes that the VBV initial delay time Td is set as the time required for the VBV buffer occupancy amount to reach half the VBV buffer capacity Cv.

Meanwhile, if the time at which the input buffer begins to receive the first data of a frame is expressed as Ti′, whereas the time at which the first data of the frame is extracted, that is, the rise time of the decoding start reference signal, is expressed as To′, the length of time between time Ti′ and time To′ is expressed as Td+ΔTd by using the time lag ΔTd shown in FIG. 8B. In this instance, the initial occupancy amount of stream data stored in the input buffer varies by an offset amount ΔOc, which is expressed by Equation (3) below, from an occupancy amount Cv/2 preset for a cable used before a change in the cable length:

ΔOc=Rt×ΔTd (3)

where Rt is a transmission rate. In the subsequent description, the original initial occupancy amount is referred to as the center of buffer variation.

If the buffer occupancy amount is not properly controlled in a situation where the offset amount is superimposed over a predicted buffer occupancy amount, a buffer problem may occur due to a shift equivalent to the center-of-buffer-variation offset amount ΔOc. The present embodiment avoids a buffer problem by presetting a VBV buffer margin for covering the maximum possible center-of-buffer-variation offset amount ΔOc and exercising code amount control. More specifically, a VBV buffer upper limit value Bh and a VBV buffer lower limit value Bl are preset as shown in FIG. 8A to let the encoder side exercise generated code amount control so that the VBV buffer occupancy amount varies between the VBV buffer upper limit value Bh and VBV buffer lower limit value Bl.

The following description relates to an exemplary configuration of an encoding/decoding device having a code amount control section in which the VBV buffer margin is predefined. The basic configuration of the entire video transmission system and the basic configuration of the encoding/decoding device will not be repeatedly described because they are the same as those indicated in FIGS. 1, 2, 5A, and 5B.

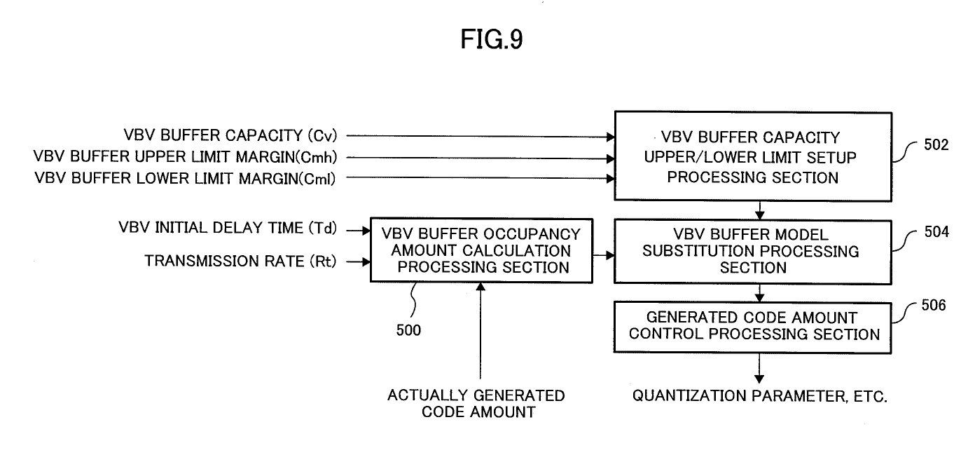

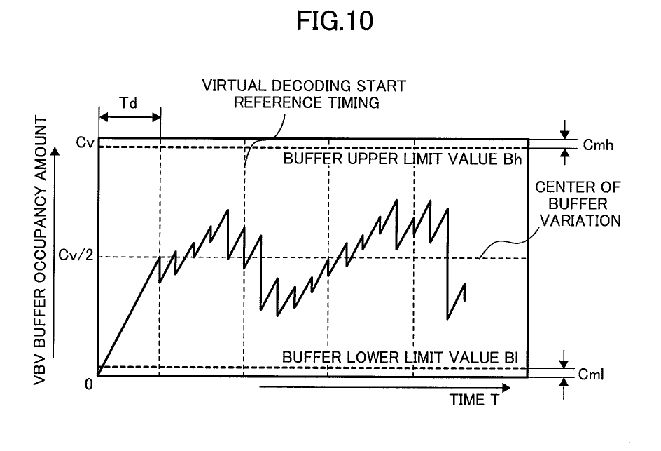

FIG. 9 is a functional block diagram illustrating the code amount control section 336 shown in FIG. 6. The hardware configuration of the video transmission system according to the present embodiment differs from that of the first embodiment in the encoder device 200. The code amount control section 336 shown in FIG. 9 includes a VBV buffer occupancy amount calculation processing section 500, a VBV buffer capacity upper/lower limit setup processing section 502, a VBV buffer model substitution processing section 504, and a generated code amount control processing section 506. The encoder device 200, which is not shown in the figure, includes a register for storing control parameters concerning the VBV buffer capacity Cv, a VBV buffer upper limit margin Cmh, a VBV buffer lower limit margin Cml, the VBV initial delay time Td, and the transmission rate Rt.

The above control parameters are supplied from the host system control device 120 to the camera 101 through the camera control unit. Therefore, the host system control device 120 includes a user interface for entering the above control parameters.

The VBV buffer occupancy amount calculation processing section 500 inputs the VBV initial delay time Td, the transmission rate Rt, and the actually generated code amount 334 from the transmission buffer 332, and calculates the VBV buffer occupancy amount Bo(T) prevailing at time T. The actually generated code amount 334 corresponds to the amount of stream data extracted from the VBV buffer.

The VBV buffer capacity upper/lower limit setup processing section 502 inputs the VBV buffer capacity Cv, VBV buffer upper limit margin Cmh, and VBV buffer lower limit margin Cml, calculates the VBV buffer upper limit value Bh and VBV buffer lower limit value Bl, and stores the calculated values Bh, Bl in a register within the encoder device 200. The VBV buffer lower limit value Bl and VBV buffer upper limit value Bh are calculated from Equations (4) and (5) below:

Bl=Cml (4)

Bh=Cv−Cmh (5)

The parameters to be given as external inputs are not limited to the aforementioned VBV buffer upper limit margin Cmh and VBV buffer lower limit margin Cml. Any parameters capable of determining the VBV buffer upper limit value Bh and VBV buffer lower limit value Bl may be used.

The VBV buffer model substitution processing section 504 inputs the VBV buffer upper limit value Bh and VBV buffer lower limit value Bl, which are calculated by the VBV buffer capacity upper/lower limit setup processing section 502 and stored in the register within the encoder device 200, outputs the difference between the VBV buffer upper limit value Bh and VBV buffer lower limit value Bl as a new VBV buffer capacity, and outputs a value obtained by subtracting the VBV buffer lower limit value Bl from the VBV buffer occupancy amount Bo(T), which is calculated by the VBV buffer occupancy amount calculation processing section 500, as a new VBV buffer occupancy amount. In other words, 504 replaces a current VBV buffer model with a new VBV buffer model in which the VBV buffer upper limit value Bh and VBV buffer lower limit value Bl are incorporated.

The generated code amount control processing section 506 uses the new VBV buffer capacity, which is output from the VBV buffer model substitution processing section 504, to determine the quantization parameter so that the VBV buffer occupancy amount changes between the VBV buffer upper limit value Bh and VBV buffer lower limit value Bl. This makes it possible to prevent the overflow and underflow of the decoder input buffer without using the PCR, PTS, or DTS even when the transmission cable length changes.

To set the optimum VBV buffer upper limit value Bh and VBV buffer lower limit value Bl, it is necessary to optimize the settings for the VBV buffer upper limit margin Cmh and VBV buffer lower limit margin Cml. The VBV buffer upper limit margin Cmh has to be equal to or greater than the maximum possible center-of-buffer-variation offset amount prevailing when the employed transmission cable length is less than a reference transmission cable length. The VBV buffer lower limit margin Cml has to be equal to or greater than the maximum possible center-of-buffer-variation offset amount prevailing when the employed transmission cable length is more than the reference transmission cable length.

Consequently, the optimum minimum VBV buffer margin setting for preventing a decoder input buffer problem satisfies the condition defined by Equation (6) below when the maximum transmission cable length acceptable by the system is Lmax, the signal propagation velocity within a cable is V, and the employed maximum transmission rate is Rt:

Cmh+Cml=(2Lmax×Rt)/V (6)

If, for instance, a transmission cable having a finite length is used in a situation where the reference transmission cable length is 0 m, the center-of-buffer-variation offset is always applied so as to decrease the input buffer occupancy amount. Therefore, the VBV buffer upper limit margin Cmh is 0. The VBV buffer lower limit margin Cml, on the other hand, is (2Lmax×Rt)/V as indicated in Equation (6).

When the buffer margin required for a reference transmission cable length of 0 m is estimated in compliance with a standard for a triaxial cable, which is a bidirectional transmission cable, the estimation result indicates that the optimum VBV buffer lower limit margin Cml is equivalent to a capacity of approximately 3 kilobytes in a situation where the maximum cable length is 1.5 km, the signal propagation velocity V is a light velocity of 300,000 km/sec, and the maximum transmission rate is 300 Mbps. This value (approximately 3 kilobytes) is sufficiently smaller than the input buffer capacity, that is, the VBV buffer capacity Cv. Therefore, the buffer occupancy amount can substantially increase to the maximum capacity of the VBV buffer. Consequently, exercising code amount control according to the present embodiment makes it possible to implement a video transmission system or encoding/decoding device that is flexibly adaptable to transmission cables having different lengths.

The generations of the phase adjustment amount Tp, decoding start reference signal 19, and camera output reference signal 14 will not be described because they can be determined in the same manner as in the first embodiment.

The control parameters concerning the VBV buffer capacity Cv, VBV buffer upper limit margin Cmh, VBV buffer lower limit margin Cml, VBV initial delay time Td, and transmission rate Rt are stored in the host system control device 120, and transmitted to the camera control unit together with the system synchronization signal at the beginning of image pick-up.

The transmitted information is acquired by the return data generation section 104 and then transferred to the camera 101. The transferred information is transmitted to the code amount control section 336 in the encoder system section 116 through the transmission control section 110, and finally entered into the VBV buffer capacity upper/lower limit setup processing section 502.

The above description assumes that the host system control device 120 transmits the control parameters concerning the VBV buffer upper limit margin Cmh and VBV buffer lower limit margin Cml. Alternatively, however, the information to be stored in the host system control device 120 may be the information about the length of a transmission cable used for the bidirectional transmission path 108. In such an instance, the host system control device 120 calculates the VBV buffer upper limit margin Cmh and VBV buffer lower limit margin Cml from the information about the transmission cable length and transmits the calculation result to the code amount control section 336.

Another alternative is to let the host system control device 120 transmit the information about the transmission cable length to the camera 101 and allow the encoder device 200 to calculate Cmh and Cml from the information about the transmission cable length. As the information about transmission cable length represents an amount that is easier to intuitively understand than Cmh and Cml, the use of the information about transmission cable length reduces the burden on a user when the control parameters are to be entered into the host system control device 120.

The present embodiment, which relates to a video transmission system or encoding/decoding device that exercises code amount control as described above, makes it possible to implement a video transmission system or encoding/decoding device flexibly adaptable to transmission cables having different lengths while maintaining the same functions as the system or device according to the first embodiment.

### Third Embodiment

A third embodiment of the present invention will now be described with reference to an exemplary configuration of a video transmission system or encoding/decoding device that is adaptable to a plurality of different video frame rates.

Various industrial video formats are used, including 60i, 24p, and 60. Accordingly, various frame rates are used for the various industrial video formats. The letters i and p are suffixes representing the word “interlaced” or “progressive.”

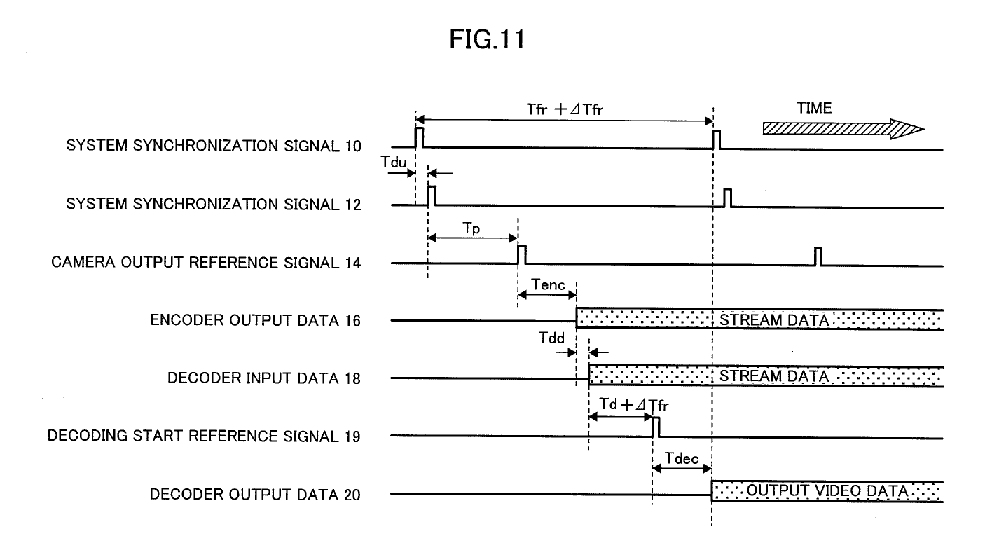

To support a plurality of frame rates, it is necessary that the employed system be adaptable to different frame display cycles Tfr. FIG. 11 is a timing diagram illustrating a situation where video having a decreased frame rate is transmitted to the video transmission system 100 for which the same phase adjustment amount Tp as shown in FIG. 4 is set. Reference numerals in FIG. 11 correlate to the numbers shown in FIG. 2, as is the case with the reference numerals in FIG. 4.

As described in conjunction with the first embodiment, Tfr, Tdu, Tenc, Tdd, and Tdec are not variable adjustment amounts but are fixed values determined by the hardware performance of the video transmission system. As such being the case, a situation where Td absorbs changes in the frame display cycle will now be discussed.

If the frame display cycle is changed from Tfr to Tfr+ΔTfr and such a change is entirely superimposed over Td, the time lag between the stream data input start time of the decoder input data 18 and the rise time of the decoding start reference signal 19 is Td+ΔTfr. If, for instance, video data in a 60i video format is transmitted in a situation where the synchronization schedule of each device element is adjusted for a 60p video format, ΔTfr is approximately 16 msec. If, for instance, the transmission rate is 300 Mbps, the amount of image data transmitted due the above time lag is approximately 4.8 MB. As this order is substantially equal to the input buffer capacity, a buffer problem occurs even when code amount control is exercised in consideration of a VBV buffer margin. It is also unfavorable from the viewpoints of image quality enhancement and device integration into a single chip.

In view of the above circumstances, the third embodiment implements a video transmission system and encoding/decoding device adaptable to a plurality of frame rates by including a function for setting an appropriate phase adjustment amount Tp for a frame rate.

The hardware configuration of the entire video transmission system and the hardware configuration of the encoding/decoding device will not be repeatedly described because they are substantially the same as those indicated in FIGS. 1, 2, 5A, and 5B. It should be noted, however, that the host system control device 120 according to the present embodiment stores a plurality of pieces of frame rate information that are compatible with a plurality of image formats. When, for instance, an operator of the video transmission system intends to change the image format and presses the associated button on a user interface of the host system control device, the host system control device 120 transmits to the camera control unit 102 and output device 118 the frame rate information compatible with the image format to be used.

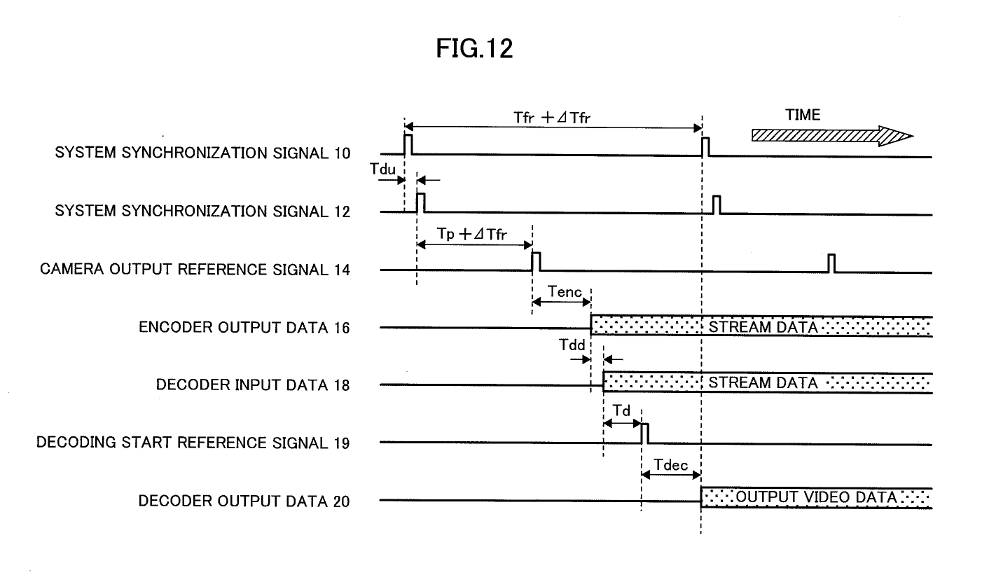

FIG. 12 is a timing diagram illustrating the operation of each device element in the video transmission system according to the present embodiment. As is obvious from FIG. 12, the video transmission system according to the present embodiment allows the phase adjustment amount Tp to absorb frame rate changes. Therefore, when the frame display cycle changes from Tfr to Tfr+ΔTfr, the phase adjustment amount is Tp+ΔTfr.

A return data generation section 104 of the camera control unit 102 calculates the phase adjustment amount Tp as indicated below in accordance with Equation (1):

Phase adjustment amount=(Tfr+ΔTfr)−Tdu−Tenc−Tdd−Td−Tdec=Tp+ΔTfr

This ensures that the time lag between the stream data input start time of the decoder input data 18 and the rise time of the decoding start reference signal 19 remains equal to the VBV initial delay time Td. Thus, the input buffer occupancy amount control method according to the first and second embodiments can be applied as is.

The present embodiment, which relates to a video transmission system or encoding/decoding device that exercises phase adjustment amount control as described above, makes it possible to implement a video transmission system or encoding/decoding device adaptable to a plurality of video frame rates while maintaining the same functions as the system or device according to the first and second embodiments. It means that a plurality of video frame rates can be supported without having to add a VBV buffer margin to the VBV buffer, that is, without having to increase the capacity of the input buffer. It is extremely effective from the viewpoints of image quality enhancement and device integration into a single chip.

### Fourth Embodiment

A fourth embodiment of the present invention will now be described with reference to an exemplary configuration of a video transmission system capable of handling a plurality of encoding/decoding devices. To prevent an image displayed on a monitor from becoming disordered upon video switching in a configuration where the video transmission system includes a plurality of encoding/decoding devices that share only one monitor through a switcher, it is necessary to ensure that the video output timing of every encoding/decoding device coincides with the frame display cycle of the output device. It should be noted that the switcher is a mechanism for video signal output switching.

In the past, it was necessary to place a synchronization adjustment frame memory between an encoding/decoding device and a switcher for timing adjustment purposes. Such a configuration is unfavorable for device downsizing, cost reduction, and power consumption reduction. In view of the above circumstances, the present embodiment provides a video transmission system that does not require the use of a synchronization adjustment frame memory even when it includes a plurality of encoding/decoding devices. The configuration of such a video transmission system is described below.

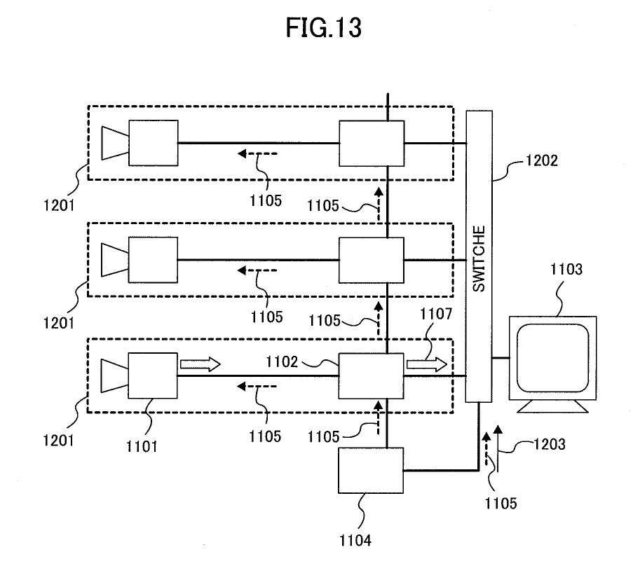

FIG. 13 is a schematic diagram illustrating the overall configuration of a video transmission system according to the present embodiment. The operations and functions of the constituent elements designated by the same reference numerals as in FIG. 1 are identical with those of the constituent elements shown in FIG. 1. The broken lines 1201 in FIG. 13 indicate an encoding/decoding device that includes the camera 1101 and the camera control unit 1102. As is the case with FIG. 1, a transmission cable is connected between the camera 1101 and the camera control unit 1102. A switcher 1202 is positioned between a plurality of encoding/decoding devices 1201 and a monitor 1103. Therefore, the output device to which the encoding/decoding devices 1201 deliver their outputs is the switcher 1202. The internal configuration of each encoding/decoding device 1201 will not be repeatedly described because it is the same as in the first to third embodiments.

The host system control device 1104 generates a system synchronization signal 1105 that is synchronized with the frame display cycle of the monitor (display device) 1103, and transmits the system synchronization signal 1105 to all the encoding/decoding devices 1201. The system synchronization signal 1105 is generated so that its cycle synchronizes with the vertical synchronization signal of the monitor. Each encoding/decoding device 1201 outputs decoded image data at a timing synchronized with the monitor's vertical synchronization signal. Meanwhile, the host system control device 1104 transmits a video switching signal 1203 to the switcher 1202 at a timing synchronized with the monitor's frame display cycle.

When control is exercised as described above, the time at which the first frame of a decoded image output from an encoding/decoding device 1201 is output to the switcher coincides with the time at which the switcher is connected to the encoding/decoding device without using a frame memory. Therefore, an image displayed on the monitor does not become disordered upon video switching. Further, when phase adjustment amount control according to the third embodiment is provided over all the encoding/decoding devices, it is possible to implement a video transmission system that can effect smooth video switching without disordering a displayed image even in a situation where the encoding/decoding devices acquire images in different formats.

The video transmission system according to the present invention is used as moving picture imaging equipment or broadcasting equipment.

What is claimed is:

1. A video transmission system having a camera capable of encoding picked-up image information, a camera control unit capable of decoding the encoded image information, and an image display section for receiving the decoded image information from the camera control unit in a predetermined frame display cycle and displaying the image information as a moving picture, the video transmission system comprising:
a host system control device for generating a reference signal referenced to the frame display cycle;
wherein the moving picture is displayed in synchronism with the frame display cycle when the operations of the camera and the camera control unit are adjusted in accordance with the reference signal.

2. The video transmission system according to claim 1, further comprising:
a cable for connecting the host system control device to the camera control unit; and
a cable for connecting the camera control unit to the camera;
wherein the reference signal is supplied from the camera control unit to the camera.

3. The video transmission system according to claim 2,
wherein the camera includes an image pick-up section for generating the image information by picking up an image and an encoder for encoding the image information;
wherein the camera control unit includes an input buffer for storing the encoded image information and a decoder for acquiring and decoding the encoded image information stored in the input buffer; and
wherein the time at which the image pick-up section starts supplying the image information to the encoder, the time at which the encoder starts encoding the image information, and the time at which the decoder starts decoding the encoded image information are adjusted in accordance with the reference signal.

4. The video transmission system according to claim 3,
wherein an adjustment amount for adjusting the time at which the image pick-up section starts supplying the image information to the encoder is transmitted from the camera control unit to the camera.

5. The video transmission system according to claim 4,
wherein the host system control device includes a user interface for entering the adjustment amount.

6. The video transmission system according to claim 4,
wherein the host system control device calculates the adjustment amount from the lengths of the cables.

7. The video transmission system according to claim 6,
wherein the host system control device includes a user interface for entering the lengths of the cables.

8. The video transmission system according to claim 1,
wherein the camera control unit includes a terminal for receiving the reference signal.

9. The video transmission system according to claim 1,
wherein the camera includes an image pick-up section for generating the image information by picking up an image and an encoder for encoding the image information;
wherein the camera control unit includes an input buffer for storing the encoded image information and a decoder for acquiring and decoding the encoded image information stored in the input buffer; and
wherein the camera predicts a buffer occupancy amount of image information to be stored in the input buffer and changes the conditions for the encoding in accordance with the result of the prediction.

10. The video transmission system according to claim 9,
wherein the camera control unit calculates the upper-limit and lower-limit values of the buffer occupancy amount and supplies the calculated values to the camera.

11. An encoding/decoding device having a camera capable of encoding picked-up image information, a camera control unit capable of decoding the encoded image information, and a function for outputting the decoded image information in a predetermined frame display cycle, the encoding/decoding device comprising:
a terminal for receiving a reference signal referenced to the frame display cycle from the outside;
wherein the decoded image information is output in synchronism with the frame display cycle when the operations of the camera and the camera control unit are adjusted in accordance with the reference signal.

12. The encoding/decoding device according to claim 11, further comprising:
a cable for connecting the camera control unit to the camera;
wherein the reference signal is supplied from the camera control unit to the camera.

13. The encoding/decoding device according to claim 11,
wherein the camera includes an image pick-up section for generating the image information by picking up an image and an encoder for encoding the image information;
wherein the camera control unit includes an input buffer for storing the encoded image information and a decoder for acquiring and decoding the encoded image information stored in the input buffer; and
wherein the time at which the image pick-up section starts supplying the image information to the encoder, the time at which the encoder starts encoding the image information, and the time at which the decoder starts decoding the encoded image information are adjusted in accordance with the reference signal.

14. The encoding/decoding device according to claim 13,
wherein an adjustment amount for adjusting the time at which the image pick-up section starts supplying the image information to the encoder is transmitted from the camera control unit to the camera.

15. A video transmission system having a plurality of encoding/decoding devices which each include a camera capable of encoding picked-up image information and a camera control unit capable of decoding the encoded image information, a switcher connected to the plurality of encoding/decoding devices, and an image display section connected to the switcher, the video transmission system comprising:
a host system control device for generating a reference signal referenced to a frame display cycle and supplying the reference signal to the plurality of encoding/decoding devices and the switcher;
wherein decoded image information output from each of the plurality of encoding/decoding devices can be selectively displayed on the image display section in synchronism with the frame display cycle when the operations of the camera, the camera control unit, and the switcher are adjusted in accordance with the reference signal.
